(19) United States
(12) Patent Application Publication
(10) Pub. No.: US 2025/0122435 A1
(43) Pub. Date: Apr. 17, 2025

(54) AVIATION FUEL COMPOSITION

(71) Applicant: SHELL USA, INC., Houston, TX (US)

(72) Inventors: Griffin Michael VALENTICH, Houston, TX (US); Elise Marie MINER, Houston, TX (US)

(21) Appl. No.: 18/695,428

(22) PCT Filed: Oct. 12, 2022
(86) PCT No.: PCT/EP2022/078322

§ 371 Date: Mar. 26, 2024

Related U.S. Application Data
(60) Provisional application No. 63/257,744, filed on Oct. 20, 2021.

(51) Int. Cl. C10L 1/04

(52) U.S. Cl. CPC C10L 1/04; C10L 2200/043; C10L 2200/0453; C10L 2200/0492; C10L 2270/04

(57) ABSTRACT

This invention provides an aviation fuel composition comprising: a cycloparaffinic kerosene generated from hydropyrolysis and hydroconversion of a solid biomass containing lignocellulose, wherein the cycloparaffinic kerosene comprises at least 90 vol % cycloparaffins and less than 1 vol % aromatics; a paraffinic-based kerosene comprising normal and iso-paraffins in an amount of greater than 95%; and optionally, a petroleum-derived kerosene. The aviation fuel composition of the present invention provides an environmentally-friendly fuel while providing improved lubricity and low temperature viscosity properties.

### FIELD OF THE INVENTION

This invention relates to an aviation fuel composition comprising a renewable cycloparaffinic kerosene. In particular, the present invention relates to an aviation fuel composition comprising a cycloparaffinic kerosene derived from hydroprocessing of solid biomass.

### BACKGROUND OF THE INVENTION

Conventional jet fuels are prepared in a refinery from a crude mineral oil source. Typically, the crude mineral oil is separated by means of distillation into a distillate kerosene fraction boiling in the aviation fuel range. If required, these fractions are subjected to hydroprocessing to reduce sulfur, oxygen and nitrogen levels.

Increasing demand for jet fuel and the environmental impact of aviation related emissions places the aviation industry at the forefront of today's global energy challenge. The increased demand for petroleum-based fuels has resulted in a higher production of greenhouse gases. In particular, the aviation industry accounts for about 2% of global CO₂ emissions. The aviation transport sector is growing 3-5% year on year, and due to the projected increasing demand for fuel and increasing production of CO₂ emissions, there is a need to explore methods to increase environmentally-friendly fuel sources while meeting jet fuel specifications.

Perhaps more tangible than the global impact of greenhouse gases is the impact of local emissions from aircraft. Emissions near and around airports have a direct impact on the air composition and therefore have been linked with poor local air quality, which can be further linked to impacts on human health. Particulates and oxides of sulfur and nitrogen are considered to be the main contributors to poor local air quality. Thus, local air quality is seen as an integral element in the pursuit of environment-friendly fuels.

Petroleum-derived jet fuels inherently contain both paraffinic and aromatic hydrocarbons. In general, paraffinic hydrocarbons offer the most desirable combustion cleanliness characteristics for jet fuels. Aromatics generally have the least desirable combustion characteristics for aircraft turbine fuel. In aircraft turbines, certain aromatics, such as naphthalenes, tend to burn with a smokier flames and release a greater proportion of their chemical energy as undesirable thermal radiation than other more saturated hydrocarbons.

The closest current option for reducing aviation emissions is blending synthesized paraffinic kerosene (“SPK”) from Fischer-Tropsch or hydrogenated vegetable oil with conventional jet fuel. Up to 50% by volume of SPK is permitted by the alternative jet fuel specification ASTM D7566. If the resulting blend meets the specification, it can be certified and considered equivalent to conventional, petroleum-derived jet fuel. Typically, these synthesized paraffinic kerosenes contain a mixture of normal and branched paraffin according to ASTM D7566.

It is important that novel fuels meet their respective jet fuel specifications without having a detrimental impact on safety or aircraft performance. Because SPK is purely paraffinic and absent of both aromatics and sulfur, it does not exhibit all of the desired properties expected from a jet fuel. For example, a gas to liquids Fischer-Tropsch-derived fuel is not considered an on-spec fuel in its pure state due to its lower density. Further, SPK fuels tend to have low volumetric energy density, which may require more fuel than can be accommodated in aircraft fuel tanks for long distance flights.

It would therefore be desirable to formulate an aviation fuel composition comprising environmentally-friendly fuel components, but which still meet the requirements of the various jet fuel specifications. It would also be desirable to formulate an environmentally-friendly aviation fuel composition which provides improvements in certain fuel properties such as lubricity and low temperature characteristics.

### SUMMARY OF THE INVENTION

The present invention provides an aviation fuel composition comprising (i) a cycloparaffinic kerosene generated from hydropyrolysis and hydroconversion of a solid biomass containing lignocellulose, wherein the cycloparaffinic kerosene comprises at least 90 vol % cycloparaffins and less than 1 vol % aromatics; (ii) a synthetic paraffinic-based kerosene comprising normal and iso-paraffins in an amount of greater than 95 vol %; and (iii) optionally, a petroleum-derived kerosene.

The present invention further provides a process for producing an aviation fuel composition comprising:
(a) feeding a solid feedstock and hydrogen to a first stage hydropyrolysis reactor, wherein the first stage hydropyrolysis reactor comprises one or more deoxygenation catalyst, and wherein the solid feedstock comprises biomass containing lignocellulose;
(b) hydropyrolysing the solid feedstock in the first stage hydropyrolysis reactor to generate a product stream comprising partially deoxygenated hydropyrolysis product, H₂O, H₂, CO₂, CO, C₁-C₃ gases, char and catalyst fines;
(c) feeding at least a portion of the product stream to a second stage hydroconversion reactor comprising one or more hydroconversion catalyst;
(d) hydroconverting the partially deoxygenated hydropyrolysis product in the product stream to generate a vapor phase product comprising substantially fully deoxygenated hydrocarbon product, H₂O, CO, CO₂, and C₁-C₃ gases;
(e) condensing the vapor phase product to generate a deoxygenated hydrocarbon liquid comprising the substantially fully deoxygenated hydrocarbon product, wherein the substantially fully deoxygenated hydrocarbon product comprises a cycloparaffinic kerosene wherein the cycloparaffinic kerosene comprises at least 90 vol % cycloparaffins and less than 1 vol % aromatics; and
(f) mixing the cycloparaffinic kerosene with a paraffinic-based kerosene comprising normal and iso-paraffins in an amount of greater than 95% and a petroleum derived jet fuel to generate the aviation fuel composition.

The present invention further provides a process for producing an aviation fuel composition, comprising:
mixing a cycloparaffinic kerosene derived from hydropyrolysis and hydroconversion of a biomass containing lignocellulose wherein the cycloparaffinic kerosene comprises at least 90 vol % cycloparaffins and less than 1 vol % aromatics with a synthetic paraffinic-based kerosene comprising normal and iso-paraffins in an amount of greater than 95%, and, optionally, a petroleum-derived jet fuel.

It has been surprisingly found that the aviation fuel composition of the present invention provides an environmentally-friendly jet fuel containing low levels of aromatics while providing unexpected improvements in certain fuel characteristics such as lubricity, and low temperature viscosity characteristics.

### BRIEF DESCRIPTION OF THE DRAWINGS

FIG. 1 is a block diagram of an embodiment of a system 10 that may be used for hydroprocessing solid feedstocks (e.g., biomass and/or waste plastics/oils) to generate one or more hydrocarbon products (e.g., GO/diesel, gasoline, kerosene, etc.) which can be used as the cycloparaffinic kerosene herein.

FIG. 2 is a ternary diagram showing the difference between the measured low temperature viscosity at −20° C. and the linear interpolation for Examples 1-18.

FIG. 3 is a ternary diagram showing the difference between the measured low temperature viscosity at −40° C. and the linear interpolation for Examples 1-18.

FIG. 4 is a ternary diagram showing the difference between the measured wear scar (lubricity) and the linear interpolation for Examples 1-18.

### DETAILED DESCRIPTION OF THE INVENTION

### Cycloparaffinic Kerosene

A first essential component of the aviation fuel composition herein is a cycloparaffinic kerosene. The cycloparaffinic kerosene used herein is generated from hydropyrolysis and hydroconversion of a solid biomass containing lignocellulose. The cycloparaffinic kerosene comprises at least 90 vol % cycloparaffins, preferably at least 92 vol % cycloparaffins, more preferably at least 95 vol % cycloparaffins (ASTM D2425). The cycloparaffinic kerosene contains low levels of aromatics, i.e. less than 1 vol % aromatics, preferably less than 0.5 vol % aromatics, more preferably less than 0.2 vol % aromatics (ASTM D6379).

From the viewpoint of optimising low temperature viscosity characteristics, the cycloparaffinic kerosene is preferably present in the aviation fuel composition at a level from 10 vol % to 95 vol %, more preferably from 20 vol % to 80 vol %, even more preferably from 40 vol % to 60 vol %, based on the total aviation fuel composition.

From the viewpoint of optimising lubricity characteristics, the cycloparaffinic kerosene is preferably present in the aviation fuel composition at a level from 40 vol % to 90 vol %, more preferably from 60 vol % to 80 vol %, based on the total aviation fuel composition.

In a preferred embodiment herein, the cycloparaffinic kerosene is generated by a hydroprocess comprising the steps of
(a) feeding a solid feedstock and hydrogen to a first stage hydropyrolysis reactor, wherein the first stage hydropyrolysis reactor comprises one or more deoxygenation catalyst, and wherein the solid feedstock comprises biomass containing lignocellulose;
(b) hydropyrolysing the solid feedstock in the first stage hydropyrolysis reactor to generate a product stream comprising a partially deoxygenated hydropyrolysis product, H₂O, H₂, CO₂, CO, C₁-C₃ gases, char and catalyst fines;
(c) feeding at least a portion of the product stream to a second stage hydroconversion reactor comprising one or more hydroconversion catalyst;
(d) hydroconverting the partially deoxygenated hydropyrolysis product in the product stream to generate a vapour phase product comprising substantially fully deoxygenated hydrocarbon product, H₂O, CO, CO₂ and C₁-C₃ gases; and
(e) condensing the vapour phase product to generate a deoxygenated hydrocarbon liquid comprising the substantially fully deoxygenated hydrocarbon product, wherein the substantially deoxygenated hydrocarbon product comprises the cycloparaffinic kerosene.

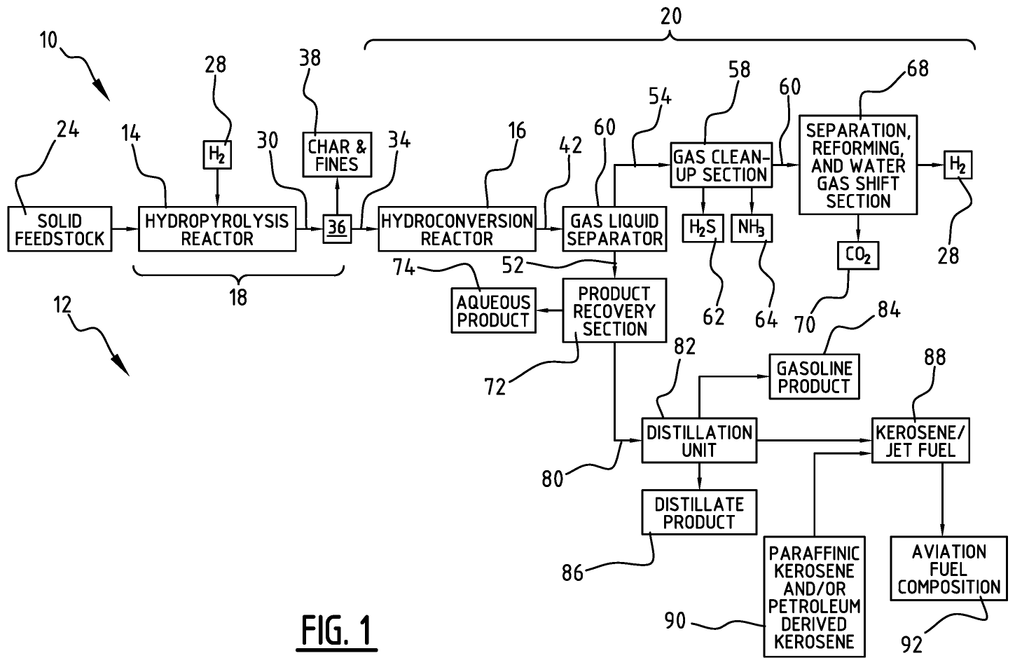

With the foregoing in mind, FIG. 1 is a block diagram of an embodiment of a system 10 that may be used for hydroprocessing solid feedstocks (e.g., biomass and/or waste plastics/oils) to generate one or more hydrocarbon products (e.g., GO/diesel, gasoline, kerosene, etc.) which can be used as the cycloparaffinic kerosene herein. As should be appreciated, the solid feedstock-derived hydrocarbon products disclosed herein may be generated by any suitable hydroprocessing technique such as those disclosed in U.S. Patent No. 9, 447, 328, which is hereby incorporated by reference in its entirety. In the illustrated embodiment, the system 10 includes a hydropyrolysis reactor 14 and a hydroconversion reactor 16. As discussed in further detail below, the reactors 14, 16 are used to convert a solid feedstock into an intermediate hydrocarbon fuel fraction (e.g., a cycloparaffinic kerosene fraction) that may be used in combination with a paraffinic kerosene and optionally, a petroleum-based kerosene base to generate an aviation fuel composition. As illustrated, the reactors 14, 16 are disposed within one of two stages. For example, the system 10 includes a first stage 18 and a second stage 20. The first stage 18 includes the hydropyrolysis reactor 14, and the second stage 20 includes the hydroconversion reactor 16. The reaction pressure in the first stage 18 and the second stage 20 may be varied to tailor the boiling point distribution and composition of the resultant hydrocarbon product(s) generated by the second stage 18. The ability to tailor the boiling point distribution and/or composition of the resultant hydrocarbon product by varying the reaction pressure may provide an efficient process for generating commercially viable hydrocarbon biofuels that meet the different requirements set forth by the location and/or market in which the hydrocarbon biofuel will be used.

### First Stage

In the illustrated embodiment, a solid feedstock 24 having biomass (e.g., lignocellulose) and/or waste plastics and molecular hydrogen (H₂) 28 are introduced into the hydropyrolysis reactor 14. The hydropyrolysis reactor 14 contains a deoxygenation catalyst that facilitates partial deoxygenation of the solid feedstock 24. For example, in the hydropyrolysis reactor 14, the solid feedstock 24 undergoes hydropyrolysis, producing an output 30 having char, partially deoxygenated products of hydropyrolysis, light gases (C₁-C₃ gases, carbon monoxide (CO), carbon dioxide (CO₂), and H₂), water (H₂O) vapor and catalyst fines. The hydropyrolysis reactor 14 may be a fluidized bed reactor (e.g., a fluidized bubbling bed reactor), fixed-bed reactor, or any other suitable reactor. In embodiments in which the hydropyrolysis reactor 14 is a fluidized bed reactor, the fluidization velocity, catalyst particle size and bulk density and solid feedstock particle size and bulk density are selected such that the deoxygenation catalyst remains in the bubbling fluidized bed, while the char produced is entrained with the partially deoxygenated products (e.g., the output 30) exiting the hydropyrolysis reactor 14. The hydropyrolysis step in the first stage 18 employs a rapid heat up of the solid feedstock 24 such that a residence time of the pyrolysis vapors in the hydropyrolysis reactor 14 is preferably less than approximately 1 minute, more preferably less than approximately 30 seconds and most preferably less than approximately 10 seconds.

The solid feedstock 24 used in the disclosed process may include a residual waste feedstock and/or a biomass feedstock containing lignin, lignocellulosic, cellulosic, hemicellulosic material, or any combination thereof. Lignocellulosic material may include a mixture of lignin, cellulose and hemicelluloses in any proportion and also contains ash and moisture. Such material is more difficult to convert into fungible liquid hydrocarbon products than cellulosic and hemicellulosic material. It is an advantage of the present process that it can be used for lignocellulose-containing biomass. Therefore, the solid feedstock 24 used in the disclosed process preferably contains lignocellulosic material. Suitable lignocellulose-containing biomass includes woody biomass and agricultural and forestry products and residues (whole harvest energy crops, round wood, forest slash, bamboo, sawdust, bagasse, sugarcane tops and trash, cotton stalks, corn stover, corn cobs, castor stalks, Jatropha whole harvest, Jatropha trimmings, de-oiled cakes of palm, castor and Jatropha, coconut shells, residues derived from edible nut production and mixtures thereof), and municipal solid wastes containing lignocellulosic material. The municipal solid waste may include any combination of lignocellulosic material (yard trimmings, pressure-treated wood such as fence posts, plywood), discarded paper and cardboard and waste plastics, along with refractories such as glass, metal. Prior to use in the process disclosed herein, municipal solid waste may be optionally converted into pellet or briquette form. The pellets or briquettes are commonly referred to as Refuse Derived Fuel in the industry. Certain feedstocks (such as algae and lemna) may also contain protein and lipids in addition to lignocellulose. Residual waste feedstocks are those having mainly waste plastics. In a preferred embodiment of the process disclosed herein, woody biomass, preferably wood, is used as the source of the biomass.

The solid feedstock 24 may be provided to the hydropyrolysis reactor 14 in the form of loose biomass particles having a majority of particles preferably less than about 3.5 millimeters (mm) in size or in the form of a biomass/liquid slurry. However, as appreciated by those skilled in the art, the solid feedstock 24 may be pre-treated or otherwise processed in a manner such that larger particle sizes may be accommodated. Suitable means for introducing the solid feedstock 24 into the hydropyrolysis reactor 14 include, but are not limited to, an auger, fast-moving (greater than about 5 minutes (m)/second (sec)) stream of carrier gas (such as inert gases and H₂), and constant-displacement pumps, impellers, turbine pumps or the like. In an embodiment of the present disclosure, a double-screw system having a slow screw for metering the solid feedstock 24 followed by a fast screw to push the solid feedstock 24 into the reactor without causing torrefaction in the screw housing is used for dosing. An inert gas or hydrogen flow is maintained over the fast screw to further reduce the residence time of the solid feedstock 24 in the fast screw housing.

The hydropyrolysis step is carried out in the hydropyrolysis reactor 14 at a temperature in the range of from approximately 350 Celsius (° C.) to approximately 600° C. and a pressure in the range of from approximately 0.1 megapascal (MPa) to approximately 0.6 MPa (approximately 1-6 bar). The heating rate of the solid feedstock 24 is preferably greater than about 100 watts/meter² (W/m²). The weight hourly space velocity (WHSV) in grams (g) biomass/g catalyst/hour (h) for the hydropyrolysis step is in the range of from approximately 0.2 h⁻¹ to approximately 10 h⁻¹, preferably in the range of from approximately 0.3 h⁻¹ to 3 h⁻¹.

The hydropyrolysis step may operate at a temperature between approximately 300° C. and 650° C. The temperatures used in hydropyrolysis rapidly devolatilize the solid feedstock 24. Thus, in a preferred embodiment, the hydropyrolysis step includes the use of an active catalyst (e.g., a deoxygenation catalyst) to stabilize the hydropyrolysis vapors. The activity of the catalyst used herein remains high and stable over a long period of time such that it does not rapidly coke. Catalyst particle sizes, for use in the hydropyrolysis reactor 14, are preferably in the range of from approximately 0.3 millimeter (mm) to approximately 4.0 mm, more preferably in the range of from approximately 0.6 mm to approximately 3.0 mm, and most preferably in the range of from approximately 1 mm to approximately 2.4 mm.

Any deoxygenation catalyst suitable for use in the temperature range of the hydropyrolysis process may be used. Preferably, the deoxygenation catalyst is selected from sulfided catalysts having one or more metals from the group consisting of nickel (Ni), cobalt (Co), molybdenum (Mo) or tungsten (W) supported on a metal oxide. Suitable metal combinations include sulfided NiMo, sulfided CoMo, sulfided NiW, sulfided CoW and sulfided ternary metal systems having any 3 metals from the family consisting of Ni, Co, Mo and W. Monometallic catalysts such as sulfided Mo, sulfided Ni and sulfided W are also suitable for use. Metal combinations for the deoxygenation catalyst used in accordance with certain embodiments of the present disclosure include sulfided NiMo and sulfided CoMo. Supports for the sulfided metal catalysts include metal oxides such as, but not limited to, alumina, silica, titania, ceria and zirconia. Binary oxides such as silica-alumina, silica-titania and ceria-zirconia may also be used. Preferably, the supports include alumina, silica and titania. In certain embodiments, the support contains recycled, regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the deoxygenation catalyst are preferably in the range of from approximately 1.5 weight percent (wt %) to approximately 50 wt % expressed as a weight percentage of calcined deoxygenation catalyst in oxidic form (e.g., weight percentage of Ni (as NiO) and Mo (as MoO₃) on calcined oxidized NiMo on alumina support). Additional elements such as phosphorous (P) may be incorporated into the deoxygenation catalyst to improve the dispersion of the metal.

The first stage of the process disclosed herein produces the output 30 having a partially deoxygenated hydropyrolysis product. The term “partially deoxygenated” as used herein denotes a material in which at least 30 weight % (wt%), preferably at least 50 wt %, more preferably at least 70 wt % of the oxygen present in the original solid feedstock 24 (e.g., lignocelluloses-containing biomass) has been removed. The extent of oxygen removal refers to the percentage of the oxygen in the solid feedstock 24 (e.g., biomass), excluding that contained in the free moisture in the solid feedstock 24. This oxygen is removed in the form of water (H₂O), carbon monoxide (CO) and carbon dioxide (CO₂) in the hydropyrolysis step. Although it is possible that nearly 100 wt % of the oxygen present in the solid feedstock 24 is removed, generally at most 99 wt %, suitably at most 95 wt % will be removed in the hydropyrolysis step.

### Char Removal

As discussed above, the output 30 produced from the hydropyrolysis step in the hydropyrolysis reactor 14 includes a mixed solid and vapor product that includes char, ash, catalyst fines, partially deoxygenated hydropyrolysis product, light gases (C₁-C₃ gases, CO, CO₂, hydrogen sulfide (H₂S), ammonia (NH₃) and H₂), H₂O vapor, vapors of C₄₊ hydrocarbons and oxygenated hydrocarbons. Char, ash and catalyst fines are entrained with the vapor phase product. Therefore, between the hydropyrolysis and hydroconversion steps, the first stage 18 and the second stage 20, respectively, char and catalyst fines are removed from the vapor phase product (e.g., the partially deoxygenated hydropyrolysis product). Any ash present may also be removed at this stage.

In certain embodiments, the hydropyrolysis reactor 14 may include solid separation equipment (e.g., cyclones), for example above a dense bed phase, to mitigate the entrainment of solid particles above a certain particle size. In addition, or alternatively, the solid separation equipment may be positioned downstream from the hydropyrolysis reactor 14 that removes the char and other solids in the output 30 to generate a vapor phase product 34. For example, as illustrated in FIG. 1, the output 30 is fed to a solid separator 36 that separates/removes the solids (e.g., char, ash and catalyst fines 38) from the output 30. The char and catalyst fines 38 may be removed from the output 30 by cyclone separation, filtering, electrostatic precipitation, inertial separation, magnetic separation, or any other suitable solid separation technique and combinations thereof. In one embodiment, the solid separator 36 includes one or more cyclones. For example, char may be removed by filtration from the vapor stream (e.g., the output 30) or by way of filtering from a wash step-ebullated bed. Back pulsing may be employed in removing char and other solids from the filters as long as hydrogen used in the disclosed process sufficiently reduces the reactivity of the pyrolysis vapors and renders the char free-flowing.

In other embodiments, the solid separator 36 includes one or more filters or a combination of cyclones, filters and other suitable solid separation equipment to remove the entrained solids from the output 30. For example, the char 38 and other solids may be removed by cyclone separation followed by hot gas filtration. The hot gas filtration removes fines not removed in the cyclones. In this embodiment, the dust cake caught on the filters is more easily cleaned compared to the char removed in the hot filtration of the aerosols produced in conventional fast pyrolysis because the hydrogen from the hydropyrolysis step stabilizes the free radicals and saturated the olefins. In accordance with another embodiment of the present disclosure, cyclone separation followed by trapping the char and catalyst fines 38 in a high-porosity solid adsorbent bed is used to remove the char and catalyst fines 38 from the output 30. By way of non-limiting example, high-porosity solid adsorbents suitable for trapping the char and catalyst fines 38 include alumina silicate materials. Inert graded bed and/or filter materials may also be used to remove the char and catalyst fines 38 from the output 30 to generate the vapour phase product 34.

The char and catalyst fines 38 may also be removed by bubbling the first stage product gas (e.g., the output 30) through a re-circulating liquid. The re-circulated liquid includes a high boiling point portion of a finished oil from this process (e.g., from the second stage 20) and is thus a fully saturated (hydrogenated), stabilized oil having a boiling point above approximately 370° C. In certain embodiments, the finished oil may be a heavy oil generated in a separate process. The char or catalyst fines 38 from the first stage 18 are captured in this liquid. A portion of the liquid may be filtered to remove the fines 38 and a portion may be re-circulated back to the hydropyrolysis reactor 14. By using a re-circulating liquid, the temperature of the char-laden process vapors from the first stage 18 is lowered to a temperature suitable for the hydroconversion step in the second stage 20, while also removing fine particulates of char and catalyst. Additionally, employing liquid filtration avoids the use of hot gas filtration.

In accordance with another embodiment of the present disclosure, large-size NiMo or CoMo catalysts, deployed in an ebullated bed, are used for char removal to provide further deoxygenation simultaneous with the removal of fine particulates. Particles of this catalyst should be large, preferably in the range of from 15 to 30 mm in size, thereby rendering them easily separable from the fine char carried over from the hydropyrolysis reactor 14, which is generally less than 200 mesh (smaller than 70 micrometers (μm).

### Second Stage

Following removal of the char and catalyst fines 38, the vapor phase product 34 (e.g., the partially deoxygenated hydropyrolysis product) together with the H₂, CO, CO₂, H₂O, and C₁-C₃ gases from the hydropyrolysis step (e.g., the first stage 18) are fed into the hydroconversion reactor 16 in the second stage 20 and subjected to a hydroconversion step. The hydroconversion step is carried out at a temperature in the range of from approximately 300° C. to approximately 600° C. and a pressure in the range of from approximately 0.1 MPa to approximately 0.6 MPa. As should be noted, pressures higher than 0.6 MPa may be used to tailor the boiling point distribution and composition of the resultant hydrocarbon product based on the desired specifications of the hydrocarbon fuel produced by the hydroprocessing. The weight hourly space velocity (WHSV) for this step is in the range of approximately 0.1 h⁻¹ to approximately 2 h⁻¹. The hydroconversion reactor 16 is a fixed bed reactor. However, in certain embodiments, the hydroconversion reactor 16 may be a fluidized bed reactor. The vapor phase product 34 undergoes hydroconversion in the presence of a hydroconversion catalyst to generate a fully deoxygenated hydrocarbon product 42. The term “fully deoxygenated” as used herein denotes a material in which at least 98 wt %, preferably at least 99 wt %, more preferably at least 99.9 wt % of the oxygen present in the original solid feedstock 24 (e.g., lignocelluloses-containing biomass) has been removed. The hydrocarbon product 42 contains light gaseous hydrocarbons, such as methane, ethane, ethylene, propane and propylene, naphtha range hydrocarbons, middle-distillate range hydrocarbons, hydrocarbons boiling above 370° C. (based on ASTM D86), hydrogen and by-products of the hydroconversion reactions such as H₂O, H₂S, NH₃, CO and CO₂.

The solid feedstock 24 used in the disclosed processes may contain metals such as, but not limited to, sodium (Na), potassium (K), calcium (Ca) and phosphorus (P). These metals may poison the hydroconversion catalyst used in the second stage 20. However, these metals may be removed with the char and ash products (e.g., the char and catalyst fines 38) in the first stage 18. Accordingly, the hydroconversion catalyst used in the hydroconversion step is protected from Na, K, Ca, P, and other metals present in the solid feedstock 24 which may otherwise poison the hydroconversion catalyst. Moreover, by hydropyrolysis of the solid feedstock 24 in the first stage 18, the hydroconversion catalyst is advantageously protected from olefins and free radicals. The conditions under which hydropyrolysis occurs in the first stage 18 stabilize free radicals generated during high temperature devolatilization of the solid feedstock 24 (e.g., biomass) by the presence of hydrogen and catalyst, thereby generating stable hydrocarbon molecules that are less prone to, for example, coke formation reactions which may deactivate the catalyst.

The hydroconversion catalyst used in the hydroconversion step includes any suitable hydroconversion catalyst having a desired activity in the temperature range of the disclosed hydroconversion process. For example, the hydroconversion catalyst is selected from sulfided catalysts having one or more metals from the group consisting of Ni, Co, Mo or W supported on a metal oxide. Suitable metal combinations include sulfided NiMo, sulfided CoMo, sulfided NiW, sulfided CoW and sulfided ternary metal systems having any three metals from the family consisting of Ni, Co, Mo and W. Catalysts such as sulfided Mo, sulfided Ni and sulfided W are also suitable for use. The metal oxide supports for the sulfided metal catalysts include, but are not limited to, alumina, silica, titania, ceria, zirconia, as well as binary oxides such as silica-alumina, silica-titania and ceria-zirconia. Preferred supports include alumina, silica and titania. The support may optionally contain regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the catalyst are in the range of from approximately 5 wt % to approximately 35 wt % (expressed as a weight percentage of calcined catalyst in oxidic form, e.g., weight percentage of nickel (as NiO) and molybdenum (as MoO₃) on calcined oxidized NiMo on alumina catalyst). Additional elements such as phosphorous (P) may be incorporated into the catalyst to improve the dispersion of the metal. Metals can be introduced on the support by impregnation or co-mulling or a combination of both techniques. The hydroconversion catalyst used in the hydroconversion step may be, in composition, the same as or different to the deoxygenation catalyst used in the hydropyrolysis step (e.g., first stage 18). In one embodiment of the present disclosure, the hydropyrolysis catalyst includes sulfided CoMo on alumina support and the hydroconversion catalyst includes sulfided NiMo on alumina support.

Following the hydroconversion step, the fully deoxygenated hydrocarbon product 42 is fed to one or more condensers that condenses the hydrocarbon product 42. The condensed hydrocarbon product 42 is fed to a gas-liquid separator 50 to provide a liquid phase product 52 having substantially fully deoxygenated C₄₊ hydrocarbon liquid and aqueous material. The term “substantially fully deoxygenated” is used herein to denote a material in which at least 90 wt % to 99 wt % of the oxygen present in the original lignocellulose containing biomass (e.g., the solid feedstock 24) has been removed. Accordingly, the resulting liquid phase product 52 (e.g., the substantially fully deoxygenated hydrocarbon C₄₊ liquid) contains less than 2 wt %, preferably less than 1 wt %, and most preferably less than 0.1 wt % oxygen. The substantially fully deoxygenated C4+ hydrocarbon liquid is compositionally different from bio-oil that is generated using other low pressure hydroprocesses. For example, the oxygen content of bio-oil is greater (e.g., between approximately 5 wt % to 15 wt %) compared to the liquid phase product 52 (e.g., less than 2 wt %). Therefore, due, in part, to the lower oxygen content of the liquid phase product 52, an amount of acid components (as measured by total acid number) and polar compounds is decreased compared to the bio-oil. By way of non-limiting example, the acid components include carboxylic acids, phenols and mixtures thereof.

The liquid phase product 52 undergoes a separation process in the gas-liquid separator 50 that separates and removes the aqueous material from the substantially fully deoxygenated C₄₊ hydrocarbon liquid. Any suitable phase separation technique may be used to separate and remove the aqueous material from the substantially fully deoxygenated C₄₊ hydrocarbon liquid, thereby generating the liquid phase product 52 having the substantially fully deoxygenated C₄₊ hydrocarbon and non-condensable gases 54. The non-condensable gases 54 includes mainly H₂, CO, CO₂ and light hydrocarbon gases (typically Ci to Cs and may also contain some C₄₊ hydrocarbons).

In certain embodiments, the non-condensable gases 54 are fed to a gas clean-up system 58. The gas clean-up system 58 removes H₂S, NH₃ and trace amounts of organic sulfur-containing compounds, if present, as by-products of the process, thereby generating a hydrocarbon stream 60 having CO, CO₂, H₂ and the light hydrocarbon gases. The gas clean-up system 58 includes one or more process units that remove H₂S 62 and NH₃ 64 from the non-condensable gases 54 as by-products of the process. The hydrocarbon stream 60 may be sent to a separation, reforming and water-gas shift section 68 where hydrogen 28 is produced from the light hydrocarbon gases in the hydrocarbon stream 60 and renewable CO₂ 70 is discharged as a by-product of the process. A fuel gas stream may be recovered as a by-product of this process. The produced hydrogen 28 may be re-used in the process. For example, the hydrogen 28 may be recycled to the hydropyrolysis reactor 14 in the first stage 18. Sufficient hydrogen is produced for use in the entire process disclosed herein. That is, the quantity of the hydrogen 28 produced by the separation, reforming and water-gas shift section 68 is equal to or greater than the hydrogen required to maintain fluidization and sustain chemical consumption of hydrogen in the process.

The liquid phase product 52 recovered from the gas-liquid separator 50 is fed to a product recovery section 72. In the product recovery section 72, aqueous product 74 is removed from the liquid phase product 52 to generate an intermediate liquid phase product 80. The intermediate liquid phase product 80 may undergo distillation to separate the substantially fully deoxygenated C₄₊ hydrocarbon liquid into fractions according to ranges of the boiling points of the liquid products contained in the intermediate liquid phase product 80. For example, the substantially fully deoxygenated C₄₊, hydrocarbon liquid in the intermediate liquid phase product 80 includes naphtha range hydrocarbons, middle distillate range hydrocarbons (e.g., gasoil, diesel), vacuum gasoil (VGO) range hydrocarbons and kerosene.

For the purpose of clarity, “kerosenes” as used herein are hydrocarbons or oxygenated hydrocarbons recovered by distillation between an atmospheric-equivalent initial boiling point (IBP) and a final boiling point (FBP) measured according to standard ASTM distillation methods. ASTM D86 initial boiling point of kerosenes may vary from between approximately 130° C. to approximately 210° C. Final boiling point of kerosenes, according to ASTM D86 distillation, may vary from between approximately 240° C. to approximately 315° C.

The term “middle distillates” as used herein are hydrocarbons or oxygenated hydrocarbons recovered by distillation between an atmospheric-equivalent initial boiling point (IBP) and a final boiling point (FBP) measured according to standard ASTM distillation methods. ASTM D86 initial boiling point of middle distillates may vary from between approximately 150° C. to approximately 220° C. Final boiling point of middle distillates, according to ASTM D86 distillation, may vary from between approximately 350° C. to approximately 380° C. “Naphtha” as used herein is one or more hydrocarbons or oxygenated hydrocarbons having four or more carbon atoms and having an atmospheric-equivalent final boiling point that is greater than approximately 90° C. but less than approximately 200° C. A small amount of hydrocarbons produced in the process (approximately less than 3 wt % of total C₄₊ hydrocarbons, and preferably less than 1 wt % of total C₄₊, hydrocarbons) boil at temperatures higher than those for the middle distillates as defined above. That is, these hydrocarbons have a boiling range similar to vacuum-gasoil produced by distillation of petroleum. Gasoline is predominantly naphtha-range hydrocarbons and is used in spark-ignition internal combustion engines. In the United States, ASTM D4814 standard establishes the requirements of gasoline for ground vehicles with spark-ignition internal combustion engines. Gasoil (GO)/diesel is predominantly middle-distillate range hydrocarbons and is used in compression-ignition internal combustion engines. In the United States, ASTM D975 standard covers the requirements of several grades of diesel fuel suitable for various types of diesel engines.

Accordingly, in the illustrated embodiment, the intermediate liquid product 80 is fed to a distillation unit 82 to recover gasoline product 84, a distillate product 86 (e.g., a middle distillate) and a kerosene/jet fuel 88.

The kerosene/jet fuel product 88 is substantially fully free from oxygen, sulfur and nitrogen. In certain embodiments, the oxygen content of the distillate product 88 is less than approximately 1.50 wt %. For example, the oxygen content may be approximately 1.40 wt %, 1.25 wt %, 0.50 wt %, 0.25 wt %, or 0.10 wt % or less. In one embodiment, the sulfur content is less than 100 ppmw. For example, the sulfur content may be approximately 75 ppmw, 50 ppmw, 25 ppmw, 10 ppmw, 5 ppmw, 1 ppmw or less. Regarding the nitrogen content, in certain embodiments, the nitrogen content of the substantially fully deoxygenated C₄₊, hydrocarbon liquid is less than 1000 ppmw. For example, the nitrogen content may be approximately 750 ppmw, 500 ppmw, 250 ppmw, 100 ppmw, 75 ppmw, 50 ppmw, 25 ppmw, 10 ppmw, or 1 ppmw or less.

The hydrocarbon liquid products such as the kerosene/jet fuel product 88 generated from hydroprocessing of solid biomass feedstock (e.g., the solid feedstock 24) may need additional processing to upgrade and improve certain product properties such as density, sulfur and/or nitrogen content, aromatics content, among others, and facilitate tailoring the overall hydrocarbon product to certain location and market specifications, among other benefits. However, the additional processing to upgrade the kerosene product 88 introduces complexity to the process, while also increasing the overall cost of producing commercially viable aviation fuel compositions having the desired specifications set forth by various fuel regulations. However, it has been recognized that by blending the kerosene product 88 with a paraffinic kerosene and/or optionally, a petroleum-derived kerosene base fuel, the product properties of the resulting aviation fuel composition (e.g., low temperature viscosity properties, lubricity and net heat of combustion properties) are improved without requiring additional processing to upgrade the kerosene product 88. Therefore, in accordance with an embodiment of the present disclosure, the kerosene product 88 is mixed with a paraffinic kerosene and/or a petroleum-derived kerosene 90 to yield a commercially viable aviation fuel composition 92 that does not require further upgrading via complex and costly processing.

### Paraffinic-Based Kerosene

A second essential component of the aviation fuel compositions of the present invention is a paraffinic-based kerosene. The paraffinic-based kerosene used herein comprises normal and iso-paraffins in an amount of greater than 95 vol %.

From the viewpoint of optimising the low temperature viscosity characteristics, the paraffinic-based kerosene is preferably present in the fuel composition in an amount of from 1 vol % to 80 vol %, more preferably from 10 vol % to 60 vol %, even more preferably from 15 vol % to 40 vol %, based on the total aviation fuel composition.

From the viewpoint of optimising the lubricity characteristics, the paraffinic-based kerosene is preferably present in the fuel composition in an amount of from 5 vol % to 50 vol %, more preferably from 10 vol % to 30 vol %, even more preferably from 15 vol % to 25 vol %, based on the total aviation fuel composition.

The paraffinic-based kerosene for use in the present invention can be derived from any suitable source as long as it is suitable for use in an aviation fuel composition. In a preferred embodiment of the present invention, the paraffinic-based kerosene is a Fischer-Tropsch derived kerosene.

While Fischer-Tropsch derived kerosene is the preferred paraffinic-based kerosene for use herein, the term “paraffinic-based kerosene” as used herein also includes those paraffinic kerosenes derived from the hydrotreating of vegetable oils (HVO) which may also be called HEFA, hydroprocessed esters and fatty acids. Feedstocks for producing HEFA can include mono-, di-and triglycerides, free fatty acids and fatty acid esters, as well as those paraffinic kerosenes derived from an alcohol to jet process.

The HVO process is based on an oil refining technology. In the process, hydrogen is used to remove oxygen from the triglyceride vegetable oil molecules and to split the triglyceride into three separate chains thus creating paraffinic hydrocarbons.

In accordance with the presence invention, the paraffinic kerosene for use herein, (e.g. the Fischer-Tropsch derived kerosene or the hydrogenated vegetable oil derived kerosene) will preferably consist of at least 95% w/w, more preferably at least 98% w/w, even more preferably at least 99.5% w/w, and most preferably up to 100% w/w of paraffinic components, preferably iso-and normal paraffins.

By “Fischer-Tropsch derived” is meant that a fuel or base oil is, or derives from, a synthesis product of a Fischer-Tropsch condensation process. The term “non-Fischer-Tropsch derived” may be interpreted accordingly. GTL (gas-to-liquid) fuels and PTL (power-to-liquid) fuels are examples of Fischer-Tropsch derived fuels.

The Fischer-Tropsch reaction converts carbon monoxide and hydrogen into longer chain, usually paraffinic, hydrocarbons: n(CO+2H₂)=(—CH₂—)n+nH₂O+heat, in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen: carbon monoxide ratios other than 2:1 may be employed if desired.

The carbon monoxide and hydrogen may themselves be derived from organic or inorganic, natural or synthetic sources, typically either from natural gas or from organically derived methane.

Gas oil, kerosene fuel and base oil products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range (see, e. g. GB2077289 and EP0147873) and/or hydroisomerisation which can improve cold flow properties by increasing the proportion of branched paraffins. EP0583836 describes a two-step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel or oil. Desired kerosene fuel fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in U.S. Pat. No. 4,125,566 and U.S. Pat. No. 4,478,955.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP0583836.

An example of a Fischer-Tropsch based process is the SMDS (Shell Middle Distillate Synthesis) described in “The Shell Middle Distillate Synthesis Process”, van der Burgt et al (vide supra). This process (also sometimes referred to as the Shell “Gas-to-Liquids” or “GTL” technology) produces diesel range products by conversion of a natural gas (primarily methane) derived synthesis gas into a heavy long-chain hydrocarbon (paraffin) wax which can then be hydroconverted and fractionated to produce liquid transport fuels such as gasoils and kerosene. Versions of the SMDS process, utilising fixed-bed reactors for the catalytic conversion step, are currently in use in Bintulu, Malaysia, and in Pearl GTL, Ras Laffan, Qatar. Kerosenes and (gas) oils prepared by the SMDS process are commercially available for instance from the Royal Dutch/Shell Group of Companies.

By virtue of the Fischer-Tropsch process, a Fischer-Tropsch derived kerosene has essentially no, or undetectable levels of, sulphur and nitrogen. Compounds containing these heteroatoms tend to act as poisons for Fischer-Tropsch catalysts and are therefore removed from the synthesis gas feed. Further, the process as usually operated produces no or virtually no aromatic components.

For example, the aromatics content of a Fischer-Tropsch kerosene, as determined for instance by ASTM D4629, will typically be below 1% w/w, preferably below 0.5% w/w and more preferably below 0.1% w/w.

Generally speaking, Fischer-Tropsch derived fuels have relatively low levels of polar components, in particular polar surfactants, for instance compared to petroleum derived fuels. It is believed that this can contribute to improved antifoaming and dehazing performance. Such polar components may include for example oxygenates, and sulphur and nitrogen containing compounds. A low level of sulphur in a Fischer-Tropsch derived fuel is generally indicative of low levels of both oxygenates and nitrogen-containing compounds, since all are removed by the same treatment processes.

The Fischer-Tropsch derived kerosene fuel used in the present invention has a distillation range typically within the 160° C. to 250° C. range (ASTM D86). Again, Fischer-Tropsch derived fuels tend to be low in undesirable fuel components such as sulphur, nitrogen and aromatics.

The Fischer-Tropsch derived kerosene used in the present invention will typically have a density (as measured by ASTM D4052) of from 720 to 780, preferably from 730 to 770, more preferably from 750 to 760 kg/m³ at 15° C.

The Fischer-Tropsch derived kerosene used in the present invention preferably has a kinematic viscosity at −40° C. (as measured according to ASTM D7945) in the range from 7 mm²/s to 12 mm²/s, preferably from 8 mm²/s to 10 mm²/s.

The Fischer-Tropsch derived kerosene used in the present invention preferably has a sulphur content (ASTM D2622) of 5 ppmw (parts per million by weight) or less, preferably of 2 ppmw or less.

The Fischer-Tropsch derived kerosene as used in the present invention is that produced as a distinct finished product, that is suitable for sale and used in applications that require the particular characteristics of a kerosene fuel. In particular, it exhibits a distillation range falling within the range normally relating to Fischer-Tropsch derived kerosene fuels, as set out above.

A fuel composition according to the present invention may include a mixture of two or more Fisher-Tropsch derived kerosene fuels.

As mentioned above, a Fischer-Tropsch derived kerosene also encompasses PTL (power-to-liquid) kerosene. In a power-to-liquid process, the syngas is derived from renewable or recycled sources such as CO₂ and H₂O, and electricity.

In accordance with the present invention, the Fischer-Tropsch derived components used herein (i.e. the Fischer-Tropsch derived kerosene) will preferably comprise no more than 3% w/w, more preferably no more than 2% w/w, even more preferably no more than 1% w/w of cycloparaffins (naphthenes), by weight of the Fischer-Tropsch derived component.

The Fischer-Tropsch derived components used herein (i.e. the Fischer-Tropsch derived kerosene) preferably comprise no more than 1% w/w, more preferably no more than 0.5% w/w, of olefins, by weight of the Fischer-Tropsch derived component.

### Petroleum-Derived Kerosene Base Fuel

A third optional, but preferred, component of the aviation fuel composition herein is a petroleum-derived kerosene base fuel.

A petroleum-derived kerosene base fuel or kerosene range hydrocarbon component is any petroleum-derived kerosene that may be useful as a jet fuel, or a jet fuel blending component having a boiling point in the range of 130° C. to 300° C., at atmospheric pressure (as measured by ASTM D86), preferably in the range of 140° C. to 300° C., and most preferably in the range of 145° C. to 300° C. For a jet fuel blending component, the kerosene base fuel (whether single stream or a mixture) can have a flash point of 38° C. or above (measured by ASTM D56), and a density at 15° C. of at least 760 kg/m³ (as measured by D4052). The kerosene base fuel may be any petroleum-derived jet fuel known to skilled artisans, including kerosene fuels meeting at least one of Jet A, Jet A-1, F-24, JP-8, Jet B or AN-8 specification. Preferably, the kerosene base fuel is a kerosene that can meet the jet fuel specification properties according to the invention.

For example, petroleum-derived kerosene fuels meeting Jet A or Jet A-1 requirements and a kerosene stream used in Jet A or Jet A-1 production are listed in Table A. It is also contemplated that petroleum-derived kerosene fuels which do not meet Jet A or Jet A-1specifications may be used as kerosene base fuels that can be upgraded to meet such specifications according to the present invention.

TABLE A
Jet fuel Produced Using:
Straight run kerosene stream.
Caustic washing of straight run kerosene.
A sweetening process such as Merox ®,
Merichem ®, or Bender process.
Hydroprocessed jet fuel.

As another example, the low boiling fraction as separated from a mineral gas oil may be used as such or in combination with petroleum-derived kerosene, suitably made at the same production location. As the low boiling fraction may already comply with a jet fuel specification, it is evident that the blending ratio between said component and the petroleum-derived kerosene may be freely chosen. The petroleum-derived kerosene will typically boil for more than 90 vol. % within the usual kerosene range of 145° C. to 300° C. (ASTM D86), depending on grade and use. It will typically have an initial boiling point in the range 130° C. to 190° C., and a final boiling point in the range 220° C. to 300° C. It will typically have a density from 775 to 840 kg/m³ at 15° C. (e.g., ASTM D4052 or IP 365). Its kinematic viscosity at −20° C. (ASTM D445) might suitably be from 1.2 to 8.0 mm²/s.

The kerosene base fuel or kerosene range hydrocarbon component may be a straight run kerosene fraction as isolated by distillation from a crude oil source or a kerosene fraction isolated from the effluent of typical refinery conversion processes, preferably hydrocracking. The kerosene fraction may also be the blend of straight run kerosene and kerosene as obtained in a hydrocracking process. Suitably the properties of the mineral derived kerosene are those of the desired jet fuel.

Aromatic content of the kerosene base fuel may vary in the range of 0 to 25 vol. %, preferably 3 to 25 vol. %, more preferably 15 to 20 vol. % based on the fuel (as measured by ASTM 1319). Typical density of the petroleum-derived kerosene at 15° C. is in the range of 775 kg/m³ to 840 kg/m³ (as measured by D4052). The kerosene base fuel most useful herein may have a density of at least 760 kg/m³, more preferably at least 775 kg/m³, to preferably at most 840 kg/m³, and more preferably at most 820 kg/m³.

The kerosene base fuel may be a single stream from a refining stream (petroleum-derived kerosene), or a mixture of one or more refining streams, or a mixture of refining streams and one or more synthetic kerosene components, or one or more synthetic kerosene streams (other than the synthetic cyclo-paraffinic blending component and the paraffinic kerosene component) approved by ASTM D7566 or equivalent specifications.

From the viewpoint of optimising low temperature viscosity characteristics the petroleum-derived kerosene, when present, is preferably present at a level from 5 to 90 vol %, more preferably from 20 to 80 vol %, even more preferably from 30 to 60 vol %, based on the total aviation fuel composition.

From the viewpoint of optimising the lubricity characteristics, the petroleum-derived kerosene, when present, is preferably present at a level from 5 to 20 vol %, more preferably from 5 to 15 vol %, even more preferably from 5 to 10 vol %, based on the total aviation fuel composition.

The aviation fuel composition of the present invention can be prepared by a process which comprises mixing the cycloparaffinic kerosene derived from hydropyrolysis and hydroconversion of a biomass containing lignocellulose with the paraffinic-based kerosene comprising normal and iso-paraffins in an amount of greater than 95 vol %, and, optionally, a petroleum-derived jet fuel. The mixing is carried out using standard blending techniques known to a person skilled in the art.

The aviation fuel compositions of the present invention preferably meet most or all of the requirements of the D7566 jet fuel specification.

The aviation fuel compositions of the present invention preferably has a boiling point in the range from 130° C. to 300° C. at atmospheric pressure, a flash point of at least 35° C., more preferably greater than 38° C., a density at 15° C. from 750 to 840 kg/m³, more preferably from 775 kg/m³ to 840 kg/m³, a freezing point below −40° C., a net heat of combustion greater than 42.8 MJ/kg, a smoke point of at least 18 mm when the naphthalene content is less than 3 vol %, a wear scar diameter less than 0.85 mm, kinematic viscosity less than 8 cSt at −20° C. and less than 12 cSt at −40° C., a maximum aromatics content of 25 vol %, and a total sulfur content less than 3000 ppm by weight.

It has surprisingly been found that the aviation fuel composition of the present invention provides improved performance properties, in particular improved low temperature viscosity and improved lubricity.

Hence according to a further aspect of the present invention there is also provided a use of an aviation fuel composition as described hereinabove for providing improved low temperature viscosity.

According to yet a further aspect of the present invention there is provided a use of an aviation fuel composition as described hereinabove for providing improved lubricity.

It has also been surprisingly found that the low temperature viscosity characteristics of an aviation fuel composition can be improved when the aviation fuel composition comprises a combination of cycloparaffinic kerosene derived from hydropyrolysis and hydroconversion of a biomass containing lignocellulose and a petroleum-derived jet fuel. Hence according to another aspect of the present invention there is provided the use of an aviation fuel composition comprising:
a cycloparaffinic kerosene generated from hydropyrolysis and hydroconversion of a solid biomass containing lignocellulose, wherein the cycloparaffinic kerosene comprises at least 90 vol % cycloparaffins and less than 1vol % aromatics; and
a petroleum-derived kerosene, for improving low temperature viscosity.

The invention will now be further illustrated by reference to the following non-limiting examples.

### EXAMPLES

### Examples 1-18

Aviation fuel compositions comprising various ratios of petroleum-derived Jet A1, synthetic GTL kerosene and bio-derived cycloparaffinic kerosene (CPK) were prepared and evaluated against ASTM D7566 semi-synthetic commercial jet fuel specification.

The petroleum-derived Jet A-1 was sourced from the Shell Haven Terminal (Essex, UK). The GTL kerosene was sourced from the Shell Pearl Refinery (Ras Laffan, Qatar). The CPK kerosene was produced from the biodiesel fraction resulting from hydropyrolysis and hydroconversion of pinewood chips according to a process similar to the process discussed above with reference to FIG. 1. The GTL-containing fuel compositions prepared are set out in Table 1 below which shows the volumetric blend ratio of CPK, GTL and conventional jet fuel. The fuel compositions were prepared by blending the constituents by hand mixing under ambient conditions.

TABLE 1

| | | Volumetric Blend Ratio | | |
|---|---|---|---|---|
| | | | | Conventional |
| Example: | Type of fuel | CPK | GTL | jet fuel |
| 1* | Neat Fuel | 0 | 0 | 1 |
| 2* | Neat Fuel | 0 | 1 | 0 |
| 3* | Neat Fuel | 1 | 0 | 0 |
| 4 | CPK/Conventional | 0.2 | 0 | 0.8 |
| 5 | CPK/Conventional | 0.4 | 0 | 0.6 |
| 6 | CPK/Conventional | 0.6 | 0 | 0.4 |
| 7 | CPK/Conventional | 0.8 | 0 | 0.2 |
| 8* | GTL/Conventional | 0 | 0.2 | 0.8 |
| 9* | GTL/Conventional | 0 | 0.4 | 0.6 |
| 10* | GTL/Conventional | 0 | 0.6 | 0.4 |
| 11 | CPK/GTL | 0.4 | 0.6 | 0 |
| 12 | CPK/GTL | 0.6 | 0.4 | 0 |
| 13 | CPK/GTL | 0.8 | 0.2 | 0 |
| 14 | CPK/GTL/Conventional | 0.2 | 0.4 | 0.4 |
| 15 | CPK/GTL/Conventional | 0.2 | 0.2 | 0.6 |
| 16 | CPK/GTL/Conventional | 0.4 | 0.2 | 0.4 |
| 17 | CPK/GTL/Conventional | 0.6 | 0.2 | 0.2 |
| 18 | CPK/GTL/Conventional | 0.4 | 0.4 | 0.2 |

*not according to the present invention

### Examples 19-34

Aviation fuel compositions comprising various ratios of petroleum-derived Jet A1, HEFA kerosene (also known as Sustainable Aviation Fuel (SAF)) and bio-derived cycloparaffinic kerosene (CPK) were prepared and evaluated against ASTM D7566 semi-synthetic commercial jet fuel specification. As used herein, the term ‘HEFA’ means Hydroprocessed Esters and Fatty Acids). The term ‘HEFA’ can be used interchangeably with the term ‘HVO’ (Hydrotreated Vegetable Oil).

The petroleum-derived Jet A-1 was sourced from the Shell Haven Terminal (Essex, UK).

The HEFA kerosene designated as ‘HEFA l’ in Table 2below was produced by hydroisomerization of a blend of an already deoxygenated C15-C18 n-paraffinic feedstock obtained from the open market and a C18 n-paraffinic feedstock obtained from Alfa Aesar. The hydroisomerization step can be carried out essentially as disclosed in Example 1 of co-pending European patent application no. EP21212771.6 with any changes in process conditions noted below. In a reactor, a single catalyst bed was used. 30 ML of a hydroisomerization catalyst comprising 0.7 wt % Pt on a carrier comprising 75 wt % silica and 25 wt % zeolite ZSM-12. The catalyst bed was operated at 340° C. The feedstock was supplied to the catalyst bed at a WHSV of 1.0 g fresh combined liquid per mL hydroisomerisation catalyst per hour. A gas stream comprising 100 vol % hydrogen was supplied to the catalyst bed at a gas-to-oil ratio of 500 NL/kg. The total pressure at the reactor outlet was 73 barg (7.3 MPag).

The HEFA kerosene designated as ‘HEFA 2’ in Table 2 below was produced by deoxygenation of a distillers corn oil feedstock, followed by a hydroisomerization step. The deoxygenation step can be carried out as taught in the Example of WO2022/038265. The hydroisomerization step can be carried out essentially as disclosed in Example 1 of co-pending European patent application no. EP21212771.6 with any changes in process conditions noted below. The feedstock of the hydroisomerization step is the n-paraffinic effluent of the deoxygenation step. In a reactor, a single catalyst bed was used. 30 ML of a hydroisomerization catalyst comprising 0.7 wt % Pt on a carrier comprising 75 wt % silica and 25 wt % zeolite ZSM-12. The catalyst bed was operated at 340° C. The feedstock was supplied to the catalyst bed at a WHSV of 1.0 g fresh combined liquid per mL hydroisomerisation catalyst per hour. A gas stream comprising 100 vol % hydrogen was supplied to the catalyst bed at a gas-to-oil ratio of 500 NL/kg. The total pressure at the reactor outlet was 73 barg (7.3 MPag).

The CPK kerosene was produced from the biodiesel fraction resulting from hydropyrolysis and hydroconversion of pinewood chips according to a process similar to the process discussed above with reference to FIG. 1.

The HEFA-containing fuel compositions prepared are set out in Table 2 below which shows the volumetric blend ratio of CPK, HEFA and conventional jet fuel. The fuel compositions were prepared by blending the constituents by hand mixing under ambient conditions.

TABLE 2

| | | Volumetric Blend Ratio | | | |
|---|---|---|---|---|---|
| | | | HEFA | HEFA | Conventional |
| Example | Type of fuel | CPK | 1 | 2 | jet fuel |
| 19 | Neat HEFA 1 | 0 | 1 | 0 | 0 |
| 20 | Neat HEFA 2 | 0 | 0 | 1 | 0 |
| 21 | HEFA | 0 | 0.5 | 0 | 0.5 |
| | 1/Conventional | | | | |
| 22 | CPK/HEFA 1 | 0.5 | 0.5 | 0 | 0 |
| 23 | CPK/HEFA | 0.2 | 0.4 | 0 | 0.4 |
| | 1/Conventional | | | | |
| 24 | CPK/HEFA | 0.2 | 0.2 | 0 | 0.6 |
| | 1/Conventional | | | | |
| 25 | CPK/HEFA | 0.4 | 0.2 | 0 | 0.4 |
| | 1/Conventional | | | | |
| 26 | CPK/HEFA | 0.6 | 0.2 | 0 | 0.2 |
| | 1/Conventional | | | | |
| 27 | CPK/HEFA | 0.4 | 0.4 | 0 | 0.2 |
| | 1/Conventional | | | | |
| 28 | HEFA | 0 | 0 | 0.5 | 0.5 |
| | 2/Conventional | | | | |
| 29 | CPK/HEFA 2 | 0.5 | 0 | 0.5 | 0 |
| 30 | CPK/HEFA | 0.2 | 0 | 0.4 | 0.4 |
| | 2/Conventional | | | | |
| 31 | CPK/HEFA | 0.2 | 0 | 0.2 | 0.6 |
| | 2/Conventional | | | | |
| 32 | CPK/HEFA | 0.4 | 0 | 0.2 | 0.4 |
| | 2/Conventional | | | | |
| 33 | CPK/HEFA | 0.6 | 0 | 0.2 | 0.2 |
| | 2/Conventional | | | | |
| 34 | CPK/HEFA | 0.4 | 0 | 0.4 | 0.2 |
| | 2/Conventional | | | | |

Neat samples of conventional Jet A-1, GTL kerosene and CPK kerosene fuel (Examples 1 to 3), neat samples of HEFA kerosene (Examples 19 and 20), as well as the fuel compositions of Examples 4-18 set out in Table 1 were tested against ASTM D7566 semi-synthetic jet fuel specification test methods. The test methods used in ASTM D7566 are shown in Table 3 below and the results of these tests are shown in Tables 4-8 below.

The fuel compositions of Examples 21-34 underwent density and viscosity measurements using the relevant test methods set out in ASTM D7566. The results of these tests are shown in Tables 9-11 below.

TABLE 3
Test methods used for analysis of samples by
property

| | | Limits (if |
|---|---|---|
| | Test Method | required by |
| Test Description | Used | ASTM D7566) |
| Density at 15° C., kg/m³ | ASTM D4052 | 775-840 |
| Initial boiling point, ° C. | ASTM D86 | — |
| 5% recovered T, ° C. | | — |
| 10% recovered T, ° C. | | 205 max |
| 20% recovered T, ° C. | | — |
| 30% recovered T, ° C. | | — |
| 40% recovered T, ° C. | | — |
| 50% recovered T, ° C. | | Report |
| 60% recovered T, ° C. | | — |
| 70% recovered T, ° C. | | — |
| 80% recovered T, ° C. | | — |
| 90% recovered T, ° C. | | Report |
| 95% recovered T, ° C. | | — |
| Final boiling point, ° C. | | 300 max |
| Distillation loss, vol % | | 1.5 max |
| Distillation residue, vol % | | 1.5 max |
| Net heat of combustion, MJ/kg | ASTM D4809 | 42.8 min |
| Total aromatics, vol % | ASTM D6379 | 8.4-26.5 |
| Freezing point, ° C. | ASTM D5972 | −40 min |
| Viscosity at −20° C., cSt | ASTM D7945 | 8.0 max |
| Viscosity at −40° C., cSt | ASTM D7945 | 12.0 max |
| Flash point, ° C. | ASTM D56 | 38 min |
| Smoke point, mm | ASTM D1322 | 18.0 min |
| Naphthalenes, vol % | ASTM D1840 | 3.0 max |
| Lubricity wear scar, mm | ASTM D5001 | 0.85 max |
| Total sulfur, ppm | ASTM D2622 | 3000 max |
| JFTOT test temperature, | ASTM D3241 | 260 |
| JFTOT pressure drop, mm Hg | ASTM D3241 | 25.0 max |
| JFTOT deposit thickness | ASTM D3241 | 85 max |
| (MWETR), nm | | |

TABLE 4

| | HEFA | HEFA | | | |
|---|---|---|---|---|---|
| | 1 | 2 | CPK | GTL | |
| | (Eg. | (Eg. | (Eg. | (Eg. | Conventional |
| Test | 19) | 20) | 3) | 2) | (Eg. 1) |
| Density at | 754.2 | 763.5 | 833.3 | 754.7 | 798.5 |
| 15° C., kg/m³ | | | | | |
| Initial | 166.6 | 178 | 144.7 | 170.5 | 148.3 |
| boiling point, | | | | | |
| ° C. | | | | | |
| 5% recovered | 173.5 | 195.9 | 156.0 | 181.7 | 163.0 |
| T, ° C. | | | | | |
| 10% recovered | 175.5 | 203.6 | 160.6 | 184.4 | 166.7 |
| T, ° C. | | | | | |
| 20% recovered | 180.2 | 216.3 | 166.8 | 188.4 | 172.8 |
| T, ° C. | | | | | |
| 30% recovered | 185.4 | 227.6 | 173.6 | 192.7 | 179.5 |
| T, ° C. | | | | | |
| 40% recovered | 190.6 | 237.7 | 181.1 | 197.5 | 186.8 |
| T, ° C. | | | | | |
| 50% recovered | 196.6 | 245 | 189.7 | 202.7 | 195.4 |
| T, ° C. | | | | | |
| 60% recovered | 203.1 | 250.5 | 200.5 | 208.5 | 205.9 |
| T, ° C. | | | | | |
| 70% recovered | 210.1 | 254.8 | 212.8 | 214.8 | 217.3 |
| T, ° C. | | | | | |
| 80% recovered | 218.7 | 258.6 | 227.9 | 221.6 | 229.7 |
| T, ° C. | | | | | |
| 90% recovered | 228.2 | 262.7 | 247.2 | 229.5 | 245.5 |
| T, ° C. | | | | | |
| 95% recovered | 234.9 | 265.6 | 258.7 | 234.6 | 259.4 |
| T, ° C. | | | | | |
| Final boiling | 240.3 | 268.4 | 269.6 | 239.1 | 274.4 |
| point, ° C. | | | | | |
| Distillation | 97.6 | 97.6 | 98.4 | 98.5 | 98.1 |
| recovery, vol % | | | | | |
| Distillation | 1.3 | 1.6 | 1.2 | 1.1 | 1.2 |
| residue, vol % | | | | | |
| Total | 98.9 | 99.2 | 98.4 | 99.6 | 99.3 |
| recovery, vol % | | | | | |
| Net heat of | — | — | 43.006 | 44.148 | 43.228 |
| combustion | | | | | |
| MJ/kg | | | | | |
| Hydrogen | — | — | 13.88 | 15.38 | 13.90 |
| content, | | | | | |
| weight % | | | | | |
| Total | <10 | <10 | <10.0 | <10.0 | 18.9 |
| aromatics, | | | | | |
| vol % | | | | | |
| Freezing | <−83.1 | <−83.1 | <−80.0 | −50.8 | −52.1 |
| point, ° C. | | | | | |
| Viscosity at | 4.187 | 4.524 | 4.447 | 4.311 | 3.740 |
| −20° C., cSt | | | | | |
| Viscosity at | — | — | 8.631 | 8.946 | 7.362 |
| −40° C., cSt | | | | | |
| Flash point, | — | — | 44.5 | 55.0 | 42.0 |
| ° C. | | | | | |
| Smoke point, | — | — | 26.8 | 55.6 | 23.4 |
| mm | | | | | |
| Naphthalenes, | — | — | 0 | 0 | 0.28 |
| mass % | | | | | |
| Naphthalenes, | — | — | <0.08 | <0.08 | 0.23 |
| vol % | | | | | |
| Ignition | — | — | 5.77 | 3.37 | 4.58 |
| delay, ms | | | | | |
| Derived cetane | — | — | 36.8 | 59.8 | 45.2 |
| number, a.u. | | | | | |
| Lubricity wear | — | — | 0.73 | 0.71 | 0.61 |
| scar, mm | | | | | |
| Total sulfur, | | | <3 | <3 | 151 |
| ppm | | | | | |
| Mercaptan | | | 0 | 0 | — |
| sulfur, m % | | | | | |
| JFTOT Test | | | 355 | 355 | — |
| Temperature, | | | | | |
| ° C. | | | | | |
| JFTOT Test | | | 5 | 5 | |
| Duration, hr | | | | | |
| JFTOT pressure | | | 0.4 | 0 | — |
| drop, mmHg | | | | | |
| JFTOT deposit | | | 79.00 | 10.25 | — |
| thickness | | | | | |
| (MWETR), nm | | | | | |

TABLE 5

| Test | Eg. 4 | Eg. 5 | Eg. 6 | Eg. 7 |
|---|---|---|---|---|
| Density 15° C., kg/m³ | 805.4 | 812.3 | 819.3 | 826.5 |
| Initial boiling point, ° C. | 148.0 | 146.8 | 146.4 | 144.9 |
| 5% recovered T, ° C. | 161.9 | 161.1 | 159.1 | 158.5 |
| 10% recovered T, ° C. | 165.3 | 161.4 | 163.4 | 161.7 |
| 20% recovered T, ° C. | 171.7 | 170.3 | 169.6 | 168.3 |
| 30% recovered T, ° C. | 178.1 | 176.8 | 175.6 | 175.0 |
| 40% recovered T, ° C. | 185.5 | 184.6 | 183.5 | 182.2 |
| 50% recovered T, ° C. | 194.6 | 193.3 | 192.2 | 191.3 |
| 60% recovered T, ° C. | 204.5 | 203.8 | 202.9 | 201.9 |
| 70% recovered T, ° C. | 216.1 | 215.4 | 214.8 | 214.1 |
| 80% recovered T, ° C. | 228.7 | 228.6 | 228.6 | 228.4 |
| 90% recovered T, ° C. | 245.3 | 245.5 | 246.2 | 246.7 |
| 95% recovered T, ° C. | 258.4 | 258.9 | 258.5 | 259.2 |
| Final boiling point, ° C. | 273.5 | 272.1 | 271.7 | 271.2 |
| Distillation recovery, | 98.3 | 98.6 | 98.5 | 98.5 |
| vol % | | | | |
| Distillation residue, vol % | 1.2 | 1.2 | 1.2 | 1.2 |
| Total recovery, vol % | 99.5 | 99.8 | 99.7 | 99.7 |
| Net heat of combustion, | 43.094 | 42.960 | 43.072 | 42.910 |
| MJ/kg | | | | |
| Hydrogen content, weight % | 13.92 | 13.94 | 13.91 | 13.93 |
| Monoaromatics, vol % | 14.4 | 11.1 | <10.0 | <10.0 |
| Diaromatics, vol % | 0.9 | 0.8 | 0.5 | 0.3 |
| Total aromatics, vol % | 15.4 | 11.9 | <10.0 | <10.0 |
| Estimated aromatics, vol %¹ | 15.12 | 11.34 | 7.56 | 3.78 |
| Freezing point, ° C. | −54.7 | −57.6 | −58.4 | −72.5 |
| Viscosity at −20° C., cSt | 3.821 | 3.940 | 4.084 | 4.255 |
| Viscosity at −40° C., cSt | 7.504 | 7.727 | 7.987 | 8.329 |
| Flash point, ° C. | 40.5 | 39.5 | 38.55 | 37.5 |
| Smoke point, mm | 23.9 | 24.6 | 25.2 | 25.8 |
| Naphthalenes, mass % | 0.88 | 0.67 | 0.45 | 0.23 |
| Naphthalenes, vol % | 0.71 | 0.55 | 0.37 | 0.19 |
| Ignition delay, ms | 4.96 | 5.17 | 5.41 | 5.62 |
| Derived cetane number, | 42.1 | 40.6 | 38.9 | 37.7 |
| a.u. | | | | |
| Lubricity wear scar, mm | 0.65 | 0.67 | 0.69 | 0.68 |
| Total sulfur, ppm | 164.0 | 120.0 | 86.0 | 38.6 |

¹Estimated aromatics content was calculated using the measured aromatics content from the neat fuels and the relative ratios of the neat fuels in the blend.

TABLE 6

| Test | Eg. 8 | Eg. 9 | Eg. 10 |
|---|---|---|---|
| Density 15° C., kg/m³ | 789.6 | 780.9 | 772.0 |
| Initial boiling point, ° C. | 153.1 | 156.9 | 159.5 |
| 5% recovered T, ° C. | 166.3 | 168.8 | 173.2 |
| 10% recovered T, ° C. | 169.6 | 173.0 | 176.2 |
| 20% recovered T, ° C. | 175.7 | 178.7 | 182.0 |
| 30% recovered T, ° C. | 182.2 | 184.9 | 187.9 |
| 40% recovered T, ° C. | 189.2 | 191.3 | 193.8 |
| 50% recovered T, ° C. | 197.5 | 199.2 | 200.6 |
| 60% recovered T, ° C. | 206.6 | 207.2 | 207.9 |
| 70% recovered T, ° C. | 216.4 | 216.1 | 215.9 |
| 80% recovered T, ° C. | 227.7 | 226.0 | 224.6 |
| 90% recovered T, ° C. | 241.6 | 238.3 | 235.3 |
| 95% recovered T, ° C. | 253.9 | 248.4 | 244 |
| Final boiling point, ° C. | 269.8 | 264.6 | 259.9 |
| Distillation recovery, vol % | 98.2 | 98.3 | 98.2 |
| Distillation residue, vol % | 1.2 | 1.2 | 1.2 |
| Total recovery, vol % | 99.4 | 99.5 | 99.4 |
| Net heat of combustion, MJ/kg | 43.344 | 43.528 | 43.680 |
| Hydrogen content, weight % | 14.22 | 14.48 | 14.78 |
| Monoaromatics, vol % | 14.7 | 10.8 | <10.0 |
| Diaromatics, vol % | 1.0 | 0.7 | 0.4 |
| Total aromatics, vol % | 15.6 | 11.5 | <10.0 |
| Estimated aromatics, vol %¹ | 15.12 | 11.34 | 7.56 |
| Freezing point, ° C. | −52.6 | −52.6 | −52.6 |
| Viscosity at −20° C., cSt | 3.816 | 3.922 | 4.039 |
| Viscosity at −40° C., cSt | 7.583 | 7.854 | 8.179 |
| Flash point, ° C. | 44.0 | 46.0 | 48.5 |
| Smoke point, mm | 26.9 | 31.4 | 37.8 |
| Naphthalenes, mass % | 0.93 | 0.70 | 0.47 |
| Naphthalenes, vol % | 0.74 | 0.55 | 0.36 |
| Ignition delay, ms | 4.40 | 4.06 | 3.83 |
| Derived cetane number, a.u. | 46.9 | 50.4 | 53.2 |
| Lubricity wear scar, mm | 0.68 | 0.70 | 0.70 |
| Total sulfur, ppm | 162.0 | 122.0 | 87.2 |

¹Estimated aromatics content was calculated using the measured aromatics content from the neat fuels and the relative ratios of the neat fuels in the blend

TABLE 7

| Test | Eg. 11 | Eg. 12 | Eg. 13 |
|---|---|---|---|
| Density 15° C., kg/m³ | 786.5 | 802.2 | 817.9 |
| Initial boiling point, ° C. | 156.1 | 152.3 | 145.6 |
| 5% recovered T, ° C. | 170.4 | 165.4 | 160.9 |
| 10% recovered T, ° C. | 173.6 | 169.7 | 164.5 |
| 20% recovered T, ° C. | 179.7 | 175.5 | 170.6 |
| 30% recovered T, ° C. | 185.7 | 181.8 | 177.6 |
| 40% recovered T, ° C. | 191.8 | 188.5 | 185.0 |
| 50% recovered T, ° C. | 198.8 | 196.3 | 193.2 |
| 60% recovered T, ° C. | 206.2 | 204.9 | 203.3 |
| 70% recovered T, ° C. | 214.7 | 214.5 | 214.2 |
| 80% recovered T, ° C. | 223.7 | 225.0 | 227.1 |
| 90% recovered T, ° C. | 235.3 | 239.0 | 243.3 |
| 95% recovered T, ° C. | 244.3 | 249.6 | 254.9 |
| Final boiling point, ° C. | 257.0 | 262.9 | 266.0 |
| Distillation recovery, vol % | 98.4 | 98.3 | 98.4 |
| Distillation residue, vol % | 1.2 | 1.2 | 1.2 |
| Total recovery, vol % | 99.6 | 99.5 | 99.6 |
| Net heat of combustion, MJ/kg | 43.696 | 43.378 | 43.318 |
| Hydrogen content, weight % | 14.74 | 14.43 | 14.14 |
| Monoaromatics, vol % | <10.0 | <10.0 | <10.0 |
| Diaromatics, vol % | 0.0 | 0.0 | 0.0 |
| Total aromatics, vol % | <10.0 | <10.0 | <10.0 |
| Estimated aromatics, vol %¹ | 0 | 0 | 0 |
| Freezing point, ° C. | −58.9 | −64.1 | −68.4 |
| Viscosity at −20° C., cSt | 4.301 | 4.325 | 4.379 |
| Viscosity at −40° C., cSt | 8.664 | 8.629 | 8.657 |
| Flash point, ° C. | 45.0 | 42.0 | 38.5 |
| Smoke point, mm | 40.3 | 34.5 | 30.0 |
| Naphthalenes, mass % | 0.00 | 0.00 | 0.00 |
| Naphthalenes, vol % | <0.08 | <0.08 | <0.08 |
| Ignition delay, ms | 4.30 | 4.79 | 5.16 |
| Derived cetane number, a.u. | 47.8 | 43.4 | 40.6 |
| Lubricity wear scar, mm | 0.71 | 0.68 | 0.66 |
| Total sulfur, ppm | <3.0 | <3.0 | <3.0 |

¹Estimated aromatics content was calculated using the measured aromatics content from the neat fuels and the relative ratios of the neat fuels in the blend.

TABLE 8

| Test | Eg. 14 | Eg. 15 | Eg. 16 | Eg. 17 | Eg. 18 |
|---|---|---|---|---|---|
| Density 15° C., kg/m³ | 787.9 | 796.7 | 803.5 | 810.9 | 804.0 |
| Initial boiling point, | 155.5 | 150.8 | 151.0 | 148.8 | 154.2 |
| 0 ° C. | | | | | |
| 5% recovered T, ° C. | 168.5 | 164.8 | 163.2 | 162.4 | 167.0 |
| 10% recovered T, ° C. | 172.0 | 168.6 | 167.3 | 165.8 | 170.3 |
| 20% recovered T, ° C. | 177.8 | 174.6 | 173.1 | 172.2 | 176.2 |
| 30% recovered T, ° C. | 183.9 | 181.1 | 179.2 | 177.9 | 182.4 |
| 40% recovered T, ° C. | 190.9 | 188.1 | 186.7 | 185.2 | 188.9 |
| 50% recovered T, ° C. | 198.3 | 196.2 | 194.8 | 193.7 | 196.5 |
| 60% recovered T, ° C. | 206.3 | 205.8 | 203.9 | 203.2 | 204.8 |
| 70% recovered T, ° C. | 215.5 | 216.0 | 214.4 | 213.8 | 214.3 |
| 80% recovered T, ° C. | 225.6 | 227.5 | 226.3 | 226.1 | 224.7 |
| 90% recovered T, ° C. | 238.2 | 241.8 | 241.2 | 241.8 | 237.6 |
| 95% recovered T, ° C. | 248.9 | 253.9 | 252.9 | 253.3 | 247.7 |
| Final boiling point, | 265.3 | 269.6 | 268.8 | 267.2 | 263.6 |
| ° C. | | | | | |
| Distillation recovery, | 98.2 | 98.2 | 98.6 | 98.4 | 98.6 |
| vol % | | | | | |
| Distillation residue, | 1.2 | 1.2 | 1.2 | 1.2 | 1.2 |
| vol % | | | | | |
| Total recovery, vol % | 99.4 | 99.4 | 99.8 | 99.6 | 99.8 |
| Net heat of | 43.70 | 43.45 | 43.27 | 43.27 | 43.47 |
| combustion, MJ/kg | 6 | 6 | 6 | 8 | 4 |
| Hydrogen content, | 14.53 | 14.22 | 14.16 | 14.28 | 14.42 |
| weight % | | | | | |
| Monoaromatics, vol % | <10.0 | 10.7 | <10.0 | <10.0 | <10.0 |
| Diaromatics, vol % | 0.4 | 0.6 | 0.4 | 0.2 | 0.2 |
| Total aromatics, vol % | <10.0 | 11.4 | <10.0 | <10.0 | <10.0 |
| Estimated aromatics, | 7.56 | 11.34 | 7.56 | 3.78 | 3.78 |
| vol %1 | | | | | |
| Freezing point, ° C. | −55.8 | −55.7 | −59.2 | −63.9 | −59.5 |
| Viscosity at −20° C., | 4.035 | 3.927 | 4.051 | 4.209 | 4.176 |
| cSt | | | | | |
| Viscosity at −40° C., | 8.075 | 7.768 | 8.003 | 8.298 | 8.333 |
| cSt | | | | | |
| Flash point, ° C. | 44.5 | 42.5 | 44.5 | 40.5 | 43.0 |
| Smoke point, mm | 32.7 | 27.6 | 28.6 | 29.4 | 33.6 |
| Naphthalenes, mass % | 0.56 | 0.72 | 0.43 | 0.20 | 0.23 |
| Naphthalenes, vol % | 0.44 | 0.58 | 0.34 | 0.17 | 0.18 |
| Ignition delay, ms | 4.33 | 4.54 | 4.82 | 5.06 | 4.49 |
| Derived cetane number, | 47.5 | 45.5 | 43.2 | 41.4 | 46.0 |
| a.u. | | | | | |
| Lubricity wear scar, | 0.68 | 0.68 | 0.69 | 0.70 | 0.69 |
| mm | | | | | |
| Total sulfur, ppm | 83.1 | 116.0 | 81.0 | 40.2 | 42.0 |

1. Estimated aromatics content was calculated using the measured aromatics content from the neat fuels and the relative ratios of the neat fuels in the blend

TABLE 9

| Test | Eg. 21 | Eg. 22 | Eg. 23 | Eg. 24 | Eg. 25 |
|---|---|---|---|---|---|
| Density 15° C., | 775.8 | 793.8 | 787.5 | 796.2 | 803.3 |
| kg/m³ | | | | | |
| Viscosity at | 3.974 | 4.307 | 4.049 | 3.974 | 4.106 |
| −20° C., cSt | | | | | |
| Linear | 3.998 | 4.35 | 4.1032 | 4.0276 | 4.1706 |
| Interpolation | | | | | |
| of Viscosity | | | | | |
| at −20° C., cSt | | | | | |
| Delta | −0.024 | −0.0485 | −0.0542 | −0.0536 | −0.0646 |
| (Measured- | | | | | |
| Interpolation) | | | | | |

TABLE 10

| Test | Eg. 26 | Eg. 27 | Eg. 28 | Eg. 29 | Eg. 30 |
|---|---|---|---|---|---|
| Density 15° C., | 810.2 | 786.8 | 780.6 | 798.4 | 791.1 |
| kg/m³ | | | | | |
| Viscosity at | 4.258 | 4.165 | 4.897 | 5.305 | 4.78 |
| −20° C., cSt | | | | | |
| Linear | 4.3136 | 4.2462 | 5.18 | 5.5375 | 5.0488 |
| Interpolation | | | | | |
| of Viscosity | | | | | |
| at −20° C., cSt | | | | | |
| Delta | −0.0556 | −0.0812 | −0.283 | −0.2325 | −0.2688 |
| (Measured- | | | | | |
| Interpolation) | | | | | |

TABLE 11

| Test | Eg. 31 | Eg. 32 | Eg. 33 | Eg. 34 |
|---|---|---|---|---|
| Density 15° C., | 798 | 805 | 812 | 798.4 |
| kg/m3 | | | | |
| Viscosity at | 4.307 | 4.448 | 4.599 | 4.937 |
| −20° C., cSt | | | | |
| Linear | 4.5004 | 4.6434 | 4.7864 | 5.1918 |
| Interpolation of | | | | |
| Viscosity at | | | | |
| −20° C., cSt | | | | |
| Delta (Measured- | −0.1934 | −0.1954 | −0.1874 | −0.2548 |
| Interpolation) | | | | |

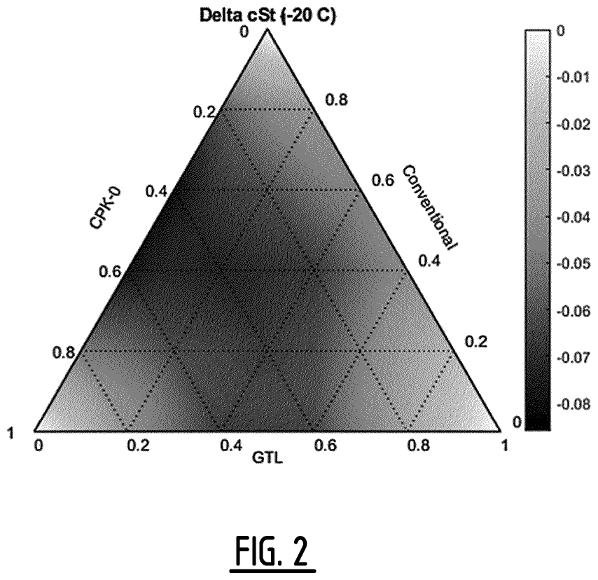

Examples 1-18 were subjected to experiments to measure their low temperature viscosity and wear scar, via D7945 and D5001, respectively. The results of these experiments are set out in Tables 4-8 above. FIG. 2 is a ternary diagram showing the difference between the measured low temperature viscosity at −20° C. and the linear interpolation for Examples 1-18.

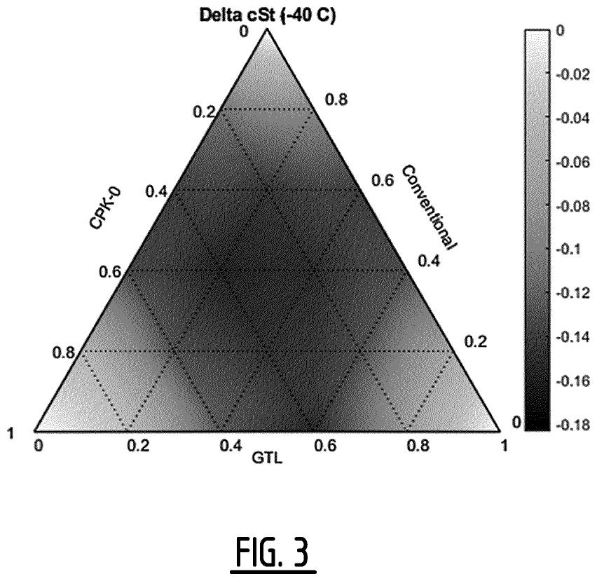

FIG. 3 is a ternary diagram showing the difference between the measured low temperature viscosity at −40° C. and the linear interpolation for Examples 1-18.

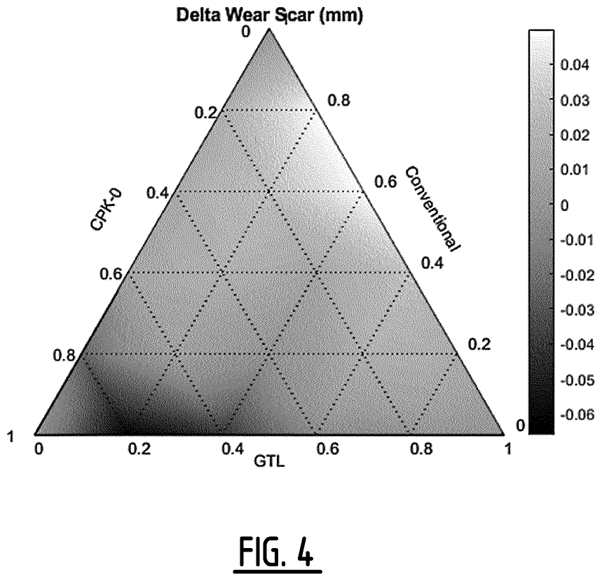

FIG. 4 is a ternary diagram showing the difference between the measured wear scar (lubricity) and the linear interpolation for Examples 1-18.

In the ternary diagrams of FIGS. 2 to 4, the darker areas represent a larger deviation from linear interpolation based on base blend components.

### Discussion

It was found that mixing Jet A-1 with both CPK and GTL afforded improved low temperature viscosity beyond that predicted by linear interpolation (FIGS. 2 and 3). Benefits in lubricity (wear scar) characteristics were also observed when Jet A-1 was mixed with both CPK and GTL (FIG. 4). These results could not have been predicted based on simple analysis of the neat fuels.

Further, it was found that mixing Jet A-1 with CPK alone afforded improved low temperature viscosity beyond that predicted by linear interpolation (FIGS. 2 and 3). These results could not have been predicted based on simple analysis of the neat fuels.

Further, it was found that mixing Jet A-1 with both CPK and HEFA afforded improved low temperature viscosity beyond that predicted by linear interpolation (see Tables 9-11). These results could not have been predicted based on simple analysis of the neat fuels.

1. An aviation fuel composition comprising:
a cycloparaffinic kerosene generated from hydropyrolysis and hydroconversion of a solid biomass containing lignocellulose, wherein the cycloparaffinic kerosene comprises at least 90 vol % cycloparaffins and less than 1 vol % aromatics:
a paraffinic-based kerosene comprising normal and iso-paraffins in an amount of greater than 95 vol %; and
optionally, a petroleum-derived kerosene.

2. An aviation fuel composition according to claim 1 wherein the paraffinic-based kerosene is a Fischer-Tropsch derived kerosene.

3. An aviation fuel composition according to claim 1 wherein the cycloparaffinic kerosene is generated by a hydroprocess comprising:
feeding a solid feedstock and hydrogen to a first stage hydropyrolysis reactor, wherein the first stage hydropyrolysis reactor comprises one or more deoxygenation catalyst, and wherein the solid feedstock comprises biomass containing lignocellulose:
hydropyrolysing a solid feedstock in a first stage hydropyrolysis reactor to generate a product stream comprising partially deoxygenated hydropyrolysis product, H2O, H2, CO2, CO, C1-C3 gases, char and catalyst fines;
feeding at least a portion of the product stream to a second stage hydroconversion reactor comprising one or more hydroconversion catalyst; and
hydroconverting the partially deoxygenated hydropyrolysis product in the product stream to generate a vapor phase product comprising substantially fully deoxygenated hydrocarbon product, H2O, CO, CO2, and C1-C3 gases;
condensing the vapor phase product to generate a deoxygenated hydrocarbon liquid comprising the substantially fully deoxygenated hydrocarbon product, wherein the substantially fully deoxygenated hydrocarbon product comprises the cycloparaffinic kerosene.

4. An aviation fuel composition according to claim 1 wherein the aviation fuel composition comprises from 40 vol % to 90 vol % of cycloparaffinic kerosene and from 2 vol % to 50 vol % of paraffinic kerosene, based on the total aviation fuel composition.

5. An aviation fuel composition according to claim 4 wherein the aviation fuel composition comprises from 5 vol % to 20 vol % of petroleum-derived kerosene, based on the total aviation fuel composition.

6. An aviation fuel composition according to clam 1 wherein the aviation fuel composition comprises from 10 vol % to 95 vol % of cycloparaffinic kerosene and from 1 vol % to 80 vol % of paraffinic kerosene, based on the total aviation fuel composition.

7. An aviation fuel composition according to claim 6 wherein the aviation fuel composition comprises from 5 vol % to 90 vol % of petroleum-derived kerosene, based on the total aviation fuel composition.

8. A process for producing an aviation fuel composition comprising:
feeding a solid feedstock and hydrogen to a first stage hydropyrolysis reactor, wherein the first stage hydropyrolysis reactor comprises one or more deoxygenation catalyst, and wherein the solid feedstock comprises biomass containing lignocellulose;
hydropyrolysing the solid feedstock in the first stage hydropyrolysis reactor to generate a product stream comprising partially deoxygenated hydropyrolysis product, H2O, H2, CO2, CO, C1-C3 gases, char and catalyst fines;
feeding at least a portion of the product stream to a second stage hydroconversion reactor comprising one or more hydroconversion catalyst;
hydroconverting the partially deoxygenated hydropyrolysis product in the product stream to generate a vapor phase product comprising substantially fully deoxygenated hydrocarbon product, H2O, CO, CO2, and C1-C3 gases;
condensing the vapor phase product to generate a deoxygenated hydrocarbon liquid comprising the substantially fully deoxygenated hydrocarbon product, wherein the substantially fully deoxygenated hydrocarbon product comprises a cycloparaffinic kerosene wherein the cycloparaffinic kerosene comprises at least 90 vol % cycloparaffins and less than 1 vol % aromatics; and
mixing the cycloparaffinic kerosene with a paraffinic-based kerosene comprising normal and iso-paraffins in an amount of greater than 95 vol % and a petroleum derived jet fuel to generate the aviation fuel composition.

9. A process for producing an aviation fuel composition, comprising:
mixing a cycloparaffinic kerosene derived from hydropyrolysis and hydroconversion of a biomass containing lignocellulose wherein the cycloparaffinic kerosene comprises at least 90 vol % cycloparaffins and less than 1 vol % aromatics with a paraffinic-based kerosene comprising normal and iso-paraffins in an amount of greater than 95 vol %, and optionally, a petroleum-derived jet fuel.

10. The process of claim 9, wherein the hydroprocessing is a two stage process comprising a first stage for hydropyrolysing the biomass to generate a product stream comprising partially deoxygenated hydropyrolysis product, H2O, H2, CO2, CO, C1-C3 gases, char and catalyst fines, and a second stage for hydroconverting the partially deoxygenated hydropyrolysis product in the product stream to generate a vapor phase product comprising substantially fully deoxygenated hydrocarbon product, H2O, CO, CO2, and C1-C3 gases, wherein the substantially fully deoxygenated product comprises the cycloparaffinic kerosene.

11. (canceled)

12. (canceled)

13. (canceled)

14. A method for improving the lubricity of an aviation fuel composition comprising the steps of:
blending:
a cycloparaffinic kerosene generated from hydropyrolysis and hydroconversion of a solid biomass containing lignocellulose, wherein the cycloparaffinic kerosene comprises at least 90 vol % cycloparaffins and less than 1 vol % aromatics; and
a paraffinic-based kerosene comprising normal and iso-paraffins in an amount of greater than 95 vol %;
to produce an aviation fuel composition, and
measuring the lubricity of the aviation fuel composition according to ASTM D5001.

15. The method of claim 14 wherein the blending step further comprises a petroleum-derived kerosene.

16. A method for improving the low temperature viscosity of an aviation fuel composition comprising the steps of:
blending:
a cycloparaffinic kerosene generated from hydropyrolysis and hydroconversion of a solid biomass containing lignocellulose, wherein the cycloparaffinic kerosene comprises at least 90 vol % cycloparaffins and less than 1 vol % aromatics; and
a paraffinic-based kerosene comprising normal and iso-paraffins in an amount of greater than 95 vol %;
to produce an aviation fuel composition, and
measuring the low temperature viscosity of the aviation fuel composition according to ASTM D7945.

17. The method of claim 16 wherein the blending step further comprises a petroleum-derived kerosene.
